(19) United States
(12) Patent Application Publication
(10) Pub. No.: US 2005/0024608 A1
(43) Pub. Date: Feb. 3, 2005

(54) Scan projector apparatus capable of repeatedly projecting multi-page images

(76) Inventor: Charlie Chou, Hsin Chu City (TW)

Correspondence Address: BIRCH STEWART KOLASCH & BIRCH, PO BOX 747, FALLS CHURCH, VA, 22040-0747, US

(21) Appl. No.: 10/898,260

(22) Filed: Jul. 26, 2004

(30) Foreign Application Priority Data
Jul. 30, 2003 (TW) 092120915

(51) Int. Cl. G03B 21/00

(52) U.S. Cl. 353/122

(57) ABSTRACT

A scan projector apparatus capable of repeatedly projecting multi-page images includes a scanner, a host computer and a projector. The scanner scans a plurality of documents one by one. The host computer receives and processes original image signals from the scanner one by one, and stores a plurality of processed final image signals into the host computer one by one. The projector receives the final image signals one by one and projects the final image signals onto a screen. The host computer may receive a selection signal caused by a user, and then output one of the final image signals corresponding to the selection signal to the projector for projection and display.

### BACKGROUND OF THE INVENTION

1. Field of the Invention

The invention relates to a scan projector apparatus, and more particularly to a scan projector apparatus capable of scanning, processing and repeatedly projecting multi-page images.

2. Description of the Related Art

The conventional presentation is prepared by printing the presentation data into a slide using a copier, and then the printed slide is placed onto the projector such that the projector can project the presentation data onto the screen. In such a processing manner, the slides will be greatly consumed, which may cause the environment protection problem. On the other hand, if a color slide has to be prepared, the cost thereof is very high.

Although a digital projector may be coupled to the computer and project the data in the computer onto the screen, directly using the digital projector cannot complete the projection if the user has no electric file.

Another conventional method may be found in Taiwan Patent Publication No. 413419, which discloses a scan projecting device capable of projecting a normal sheet. In this patent, however, only one page of image signal can be processed at a time owing to the limitation in the hardware and software architectures, and the scanned and processed image signal or signals cannot be repeatedly projected. For example, during the presentation, associated frames are usually displayed alternatively, and this patent cannot achieve this function.

In addition, the connection port of the projector in this patent is occupied by the scanner. If the user wants to make the presentation using the normal sheets and computer files simultaneously, he or she has to switch the signal source of the projector between the scanner and the computer, thereby causing inconvenience of usage.

Thus, how to provide a scan projector apparatus capable of repeatedly projecting multi-page images and switching between different signal sources is a problem to be solved by this invention.

### SUMMARY OF THE INVENTION

It is therefore an object of the invention to provide a scan projector apparatus capable of repeatedly projecting multi-page images.

Another object of the invention is to provide a scan projector apparatus capable of switching between different signal sources.

The invention achieves the above-identified objects by providing a scan projector apparatus capable of repeatedly projecting multi-page images. The apparatus includes a scanner, a host computer and a projector. The scanner scans a plurality of documents one by one. The host computer receives and processes original image signals from the scanner one by one, and stores a plurality of processed final image signals into the host computer one by one. The projector receives the final image signals one by one and projects the final image signals onto a screen. The host computer may receive a selection signal caused by a user, and then output one of the final image signals corresponding to the selection signal to the projector for projection and display.

Therefore, the user can input the selection signal on the software interface displaced on the display of the host computer or the screen, and thus enables the scan projector apparatus to perform the scan projection operation.

### BRIEF DESCRIPTION OF THE DRAWINGS

FIG. 1 is a schematic illustration showing a scan projector apparatus according to a first embodiment of the invention.

FIG. 2 is a schematic illustration showing a scan projector apparatus according to a second embodiment of the invention.

FIG. 3 is a schematic illustration showing a scan projector apparatus according to a third embodiment of the invention.

### DETAILED DESCRIPTION OF THE INVENTION

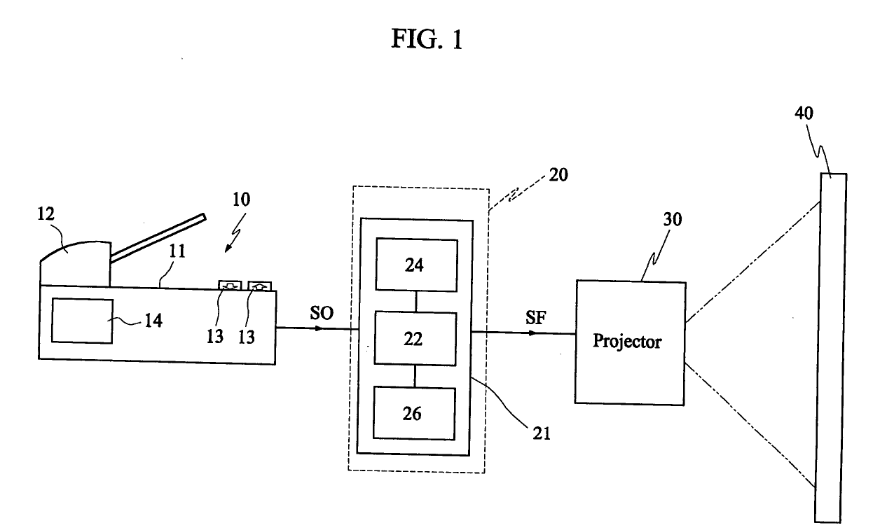

FIG. 1 is a schematic illustration showing a scan projector apparatus according to a first embodiment of the invention. Referring to FIG. 1, the scan projector apparatus of this embodiment includes a scanner 10, a host computer 20, and a projector 30. The scanner 10 scans a plurality of documents one by one and outputs a plurality of original image signals SO. The scanner 10 may be a typical flatbed scanner, a typical sheet-fed scanner, or a multi-function scanner with an automatic document feeder.

The scanner 10 may include an automatic document feeder 12 and a scan module 14. The automatic document feeder 12 feeds the document across the scan module 14 such that the scan module 14 can scan the image of the document.

The scanner 10 further includes a set of selection buttons 13, which is disposed on a housing 11 of the scanner 10, for outputting a selection signal to a selection unit 26 of the host computer 20 under the control of the user. Alternatively, the projector 30 may include a set of selection buttons (not shown), which is disposed on a housing of the projector 30, for outputting a selection signal to the selection unit 26 of the host computer 20 under the control of the user. Usually, the user can view the previous or next page by operating the “PREVIOUS” or “NEXT” button. Thus, the user can find the frame he or she wants to project through the projected frame on a screen 40.

The host computer 20 receives and processes the original image signals SO from the scanner 10 one by one such that the processed original image signals SO become a plurality of final image signals SF, which is stored in the host computer 20.

The host computer 20 includes an image processing unit 22, a memory 24 and the selection unit 26 disposed in the host 21. The image processing unit 22 processes the original image signals SO, stores the original image signals SO into the memory 24, and further gets the original image signals SO from the memory 24 for output. The memory 24, which is coupled to the image processing unit 22, is for storing the final image signals SF. The selection unit 26 receives the selection signal and controls the image processing unit 22 to load one of the final image signals SF corresponding to the selection signal for output.

The projector 30 receives the final image signals SF coming from the host computer 20 one by one, and processes and projects the final image signals SF onto the screen 40. The host computer 20 can receive a selection signal caused by the user, and thus output one of the final image signals SF, which corresponds to the selection signal, to the projector 30 for projection and display.

For example, the user can scan and present the slide at the same time. When the previously presented image is to be presented again, the user can select the image through the software interface, which is displayed on the screen 40 and serves as the selection unit 26. In addition, the user also can control the scan projector apparatus by the keys or software interface on the scanner.

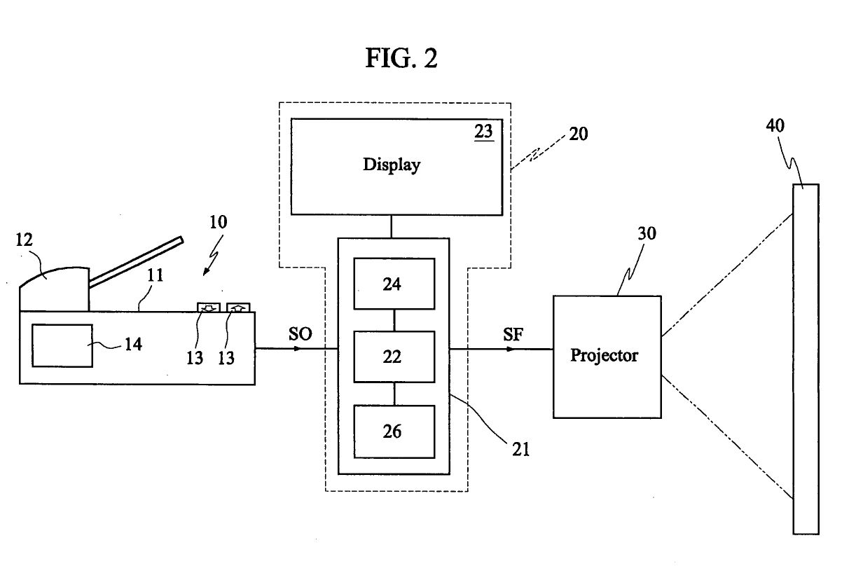

FIG. 2 is a schematic illustration showing a scan projector apparatus according to a second embodiment of the invention. As shown in FIG. 2, the scanner 10 transfers the original image signal SO to the host computer 20, which processes the original image signal SO into the final image signal SF and then transfers the final image signal SF to the projector 30, and the projector 30 can output the final image signal SF to the screen 40. When the previously presented image is to be presented again, the user can select the image through the software interface, which is displayed on the display 23 and serves as the selection unit 26.

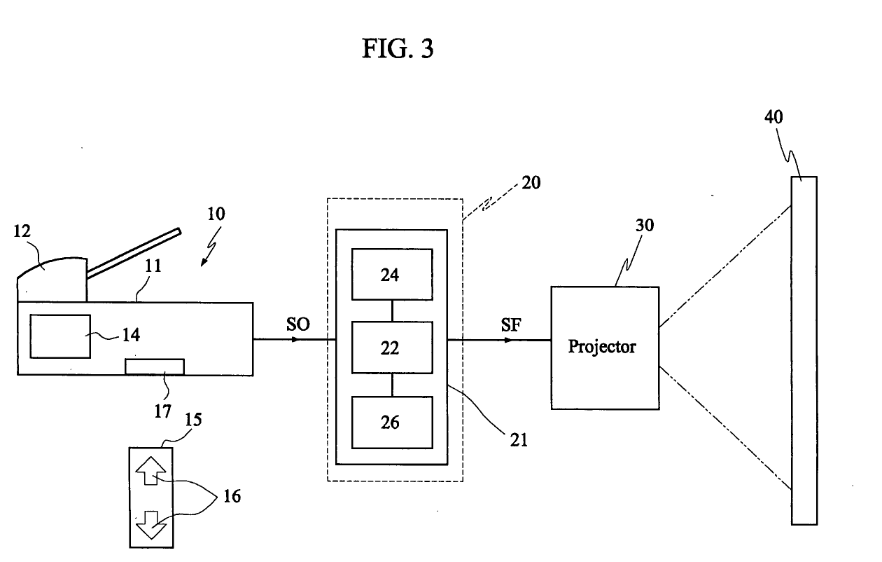

FIG. 3 is a schematic illustration showing a scan projector apparatus according to a third embodiment of the invention. As shown in FIG. 3, in the scan projector apparatus of this embodiment, the scanner 10 includes a remote controller 15 and a receiver 17. The receiver 17 is disposed on the housing 11 to receive a selection signal coming from the remote controller 15 and output the selection signal to the selection unit 26. The remote controller 15 can be easily carried by the user and has a set of selection buttons 16 such that the selection signal can be outputted under the control of the user. Consequently, when the user is presenting the projected frame, he or she only has to put a stack of documents onto the automatic document feeder 12, and then the subsequent operations can be controlled by the remote controller 15.

Hence, the scan projector apparatus of the invention can scan a first document for projection and display. When the user is explaining the content of the first document, the scanner scans a second document, a third document, and even the documents after the third one. Consequently, the to-be-presented frame can be projected without waiting for all of the documents have been scanned. In addition, the user also can easily select the previously presented image using the selection unit. In the conventional scan projecting device, however, if the previously presented frame is to be presented again, the to-be-presented document needs to be scanned again, which is quite inconvenient to the user. The scan projector apparatus of the invention is proposed to solve this problem and thus to provide a more convenient and human-oriented scan projector apparatus.

Furthermore, it is possible to prevent the connection port of the projector of the invention from being occupied by the scanner. If the user wants to make the presentation using the normal sheets and the computer files, he or she does not have to switch the signal source of the projector between the scanner and computer. Thus, it is quite convenient in usage.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A scan projector apparatus capable of repeatedly projecting multi-page images, comprising:
a scanner for scanning a plurality of documents and outputting a plurality of original image signals one by one;
a host computer for receiving and processing the original image signals coming from the scanner one by one and generating a plurality of final image signals to be stored into the host computer; and
a projector for receiving the final image signals coming from the host computer and projecting the final image signals onto a screen one by one, wherein the host computer can receive a selection signal caused by a user and then output one of the final image signals, which corresponds to the selection signal, to the projector for projection and display.

2. The scan projector apparatus according to claim 1, wherein the host computer comprises:
an image processing unit for processing the original image signals;
a memory, which is coupled to the image processing unit, for storing the final image signals; and
a selection unit for receiving the selection signal and controlling the image processing unit to load one of the final image signals, which corresponds to the selection signal, for output.

3. The scan projector apparatus according to claim 2, wherein the selection unit is a software interface displayed on a display of the host computer.

4. The scan projector apparatus according to claim 2, wherein the selection unit is a software interface displayed on the screen.

5. The scan projector apparatus according to claim 2, wherein the scanner comprises:
a set of selection buttons, which is disposed on a housing of the scanner, for outputting the selection signal to the selection unit under control of the user.

6. The scan projector apparatus according to claim 2, wherein the scanner comprises:
a remote controller, which has a set of selection buttons and can be carried by the user, for outputting the selection signal under control of the user;
a receiver for receiving the selection signal from the remote controller and outputting the selection signal to the selection unit.

7. The scan projector apparatus according to claim 2, wherein the scanner comprises:
an automatic document feeder for feeding the documents one by one so that the documents may be scanned one by one.

8. The scan projector apparatus according to claim 2, wherein the projector comprises:
a set of selection buttons, which is disposed on a housing of the projector, for outputting the selection signal to the selection unit under control of the user.
